(19) United States
(12) Patent Application Publication
(10) Pub. No.: US 2006/0260466 A1
(43) Pub. Date: Nov. 23, 2006

(54) Hydrogen permeable member and method for production thereof

(75) Inventors: Takeharu Tanaka, Kobe-shi (JP); Kazuhisa Kawata, Kobe-shi (JP); Hiroyuki Mitani, Kobe-shi (JP); Toshiki Sato, Kobe-shi (JP); Noboru Nakao, Kobe-shi (JP); Takeshi Yamashita, Kobe-shi (JP); Keita Yura, Kobe-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd.), Kobe-shi (JP)

(21) Appl. No.: 11/410,038

(22) Filed: Apr. 25, 2006

(30) Foreign Application Priority Data
May 23, 2005 (JP) 2005-150148

(51) Int. Cl. B01D 53/30

(52) U.S. Cl. 95/11

(57) ABSTRACT

Disclosed herein is a hydrogen permeable member composed of a metal porous body and a hydrogen permeable membrane placed thereon, with a diffusion preventing layer interposed between them, wherein the metal porous body has those parts on which the diffusion preventing layer is absent and such parts are filled with metal oxide particles and/or porous metal oxide. This structure prevents direct contact between the metal porous body and the hydrogen permeable membrane, thereby relieving the latter from deterioration by diffusion of metal from the former.

### BACKGROUND OF THE INVENTION

1. Field of the Invention

The present invention relates to a hydrogen permeable member which selectively separates hydrogen gas from crude gas containing hydrogen gas, thereby obtaining high-purity hydrogen gas (simply referred to as hydrogen hereinafter).

2. Description of the Related Art

Gas separation by membrane is attracting attention because of its low energy consumption. Recent developments in fuel cells raised a problem of efficiently producing high-purity hydrogen gas as the fuel.

A typical method of producing hydrogen gas is by thermal cracking of hydrocarbon gas (such as town gas and natural gas) to give crude gas and subsequent separation of high-purity hydrogen gas from said crude gas. Unfortunately, this method needs selective separation of hydrogen gas from cracked crude gas containing hydrogen gas as well as carbon monoxide and carbon dioxide in large amounts.

Selective separation of hydrogen gas from crude gas is accomplished by means of a hydrogen permeable member (which is sometimes referred to as a hydrogen selectively permeable member). A hydrogen permeable member is a sheet-like product composed of a porous body and a hydrogen permeable membrane formed thereon (the latter being sometimes referred to as a membrane selectively permeable to hydrogen). The hydrogen permeable membrane, which is weak in itself, is supported on a porous body. The porous body is made of metal with good oxidation resistance, good durability, and good handling for connection. The hydrogen permeable membrane is usually a metal film that permits hydrogen permeation.

There is an example of hydrogen permeable member which consists of a metal porous body, which is a sintered body of iron-based alloy such as stainless steel, and a hydrogen permeable membrane of Pd, which is formed directly on said sintered body. The disadvantage of this hydrogen permeable member is that Fe in the porous body diffuses and migrates to the hydrogen permeable membrane during operation, thereby alloying the hydrogen permeable membrane with Fe and deteriorating its hydrogen permeability. This is harmful to the durability of the hydrogen separating facility.

The present inventors proposed a way of preventing the metal contained in the metal porous body from diffusing and migrating to the hydrogen permeable membrane by forming a diffusion preventing layer on the surface of the metal porous body before the formation of the hydrogen permeable membrane. (See Patent Document 1.) However, their continued researches revealed that there is an instance in which the diffusion preventing layer on the surface of the metal porous body cannot prevent the metal porous body from coming into contact with the hydrogen permeable membrane. Thus, their proposed method needs further improvement.

Incidentally, Patent Document 2 discloses a method for simply producing a defect-free thin hydrogen permeable membrane. (This method is not concerned with the technology of preventing the hydrogen permeable membrane from coming into direct contact with the metal porous body.) This method consists of steps of filling with fine powder the interstices that open in the surface of the inorganic porous body as the support, forming a palladium thin film by plating, and forming a hydrogen permeable membrane of palladium on said thin film by chemical deposition. However, this technology is not concerned with the selective permeation of hydrogen being deteriorated by metal diffusion from the inorganic porous body to the palladium thin film.
Patent Document 1: Japanese Patent Laid-open No. 2002-219341 (Claim, Paragraphs 0042-0044).
Patent Document 2: Japanese Patent Laid-open No. 2004-122006 (Claim, Paragraphs 0011, 0015, and 0035-0037).

### OBJECT AND SUMMARY OF THE INVENTION

The present invention was completed in view of the foregoing. It is an object of the present invention to provide a hydrogen permeable member which eliminates direct contact between the metal porous body and the hydrogen permeable membrane, thereby preventing diffusion of metal from the former to the latter and protecting the latter from deterioration by diffused metal.

As mentioned above, the diffusion preventing layer on the surface of the metal porous body does not necessarily prevent direct contact between the metal porous body and the hydrogen permeable membrane. This is because the diffusion preventing layer cannot entirely cover pores and holes varying in size and shape which remain in the surface of the metal porous body. (Pores and holes will be collectively referred to openings hereinafter.) Particularly, the diffusion preventing layer formed by physical deposition does not cover openings although it covers the surface of the metal porous body in which there exist no openings. Therefore, the hydrogen permeable membrane formed on openings not covered by the diffusion preventing layer is liable to come into direct contact with the metal porous body, and such direct contact permits diffusion of metal from the metal porous body into the hydrogen permeable membrane, thereby deteriorating the latter.

With the foregoing in mind, the present inventors carried out investigations into the method for certainly preventing direct contact between the metal porous body and the hydrogen permeable membrane and preventing diffusion of metal from the former into the latter, thereby protecting the latter from deterioration. As the result, it was found that this object is achieved by filling with particles and/or porous body the openings of pores or recesses in the surface of the metal porous body. This finding led to the present invention.

The gist of the present invention resides in a hydrogen permeable member composed of a metal porous body and a hydrogen permeable membrane placed thereon, with a diffusion preventing layer interposed between them, wherein the metal porous body has those parts on which the diffusion preventing layer is absent and such parts are filled with metal oxide particles and/or porous metal oxide.

The gist of the present invention resides also in a hydrogen permeable member composed of a metal porous body and a hydrogen permeable membrane placed thereon, with a diffusion preventing layer interposed between them, wherein the metal porous body has pores that open in the surface thereof and/or recesses that appear in the surface thereof, and the openings of such pores and/or recesses are filled with metal oxide particles and/or porous metal oxide.

According to the present invention, the metal porous body should preferably be a sintered body of stainless steel, the hydrogen permeable membrane should preferably be a hydrogen permeable metal film of Pd or alloy thereof, the diffusion preventing layer should preferably be a ceramics layer, and the metal oxide particles should preferably be those which have the maximum particle diameter smaller than 1 μm.

According to the present invention, the hydrogen permeable member is produced by providing the metal porous body with the diffusion preventing layer on the surface thereof, filling with metal oxide particles and/or porous metal oxide those parts of the metal porous body on which the diffusion preventing layer is absent, and finally forming the hydrogen permeable membrane on the diffusion preventing layer.

Also, according to the present invention, the hydrogen permeable member is produced by providing the metal porous body with the diffusion preventing layer on the surface thereof, filling with metal oxide particles and/or porous metal oxide those pores which open in the surface thereof and/or those recesses which appear in the surface thereof, and finally forming the hydrogen permeable membrane on the diffusion preventing layer.

According to the present invention, the diffusion preventing layer and the hydrogen permeable membrane should preferably be formed by physical vapor deposition. In the case where the hydrogen permeable membrane is formed from physical vapor deposition, the metal oxide particles used for filling should preferably be those which have the maximum particle diameter smaller than 1 μm.

### Effect of the Invention

The hydrogen permeable member according to the present invention is characterized in that those parts of the metal porous body on which the diffusion prevent layer is absent (or the openings of pores or recesses appearing on the surface of the metal porous body) are filled with metal oxide particles and/or porous metal oxide. This structure prevents direct contact between the metal porous body and the hydrogen permeable membrane even though the surface of the metal porous body is not completely covered with the diffusion preventing layer. The result is protection of the hydrogen permeable membrane from deterioration.

### BRIEF DESCRIPTION OF THE DRAWINGS

FIG. 1 is an enlarged schematic sectional view showing the hydrogen permeable membrane pertaining to the present invention.

FIG. 2 is a schematic diagram showing how metal crystals grow.

FIG. 3 is a schematic diagram showing how metal crystals grow.

FIG. 4 is a micrograph of the surface of the hydrogen permeable member obtained in Experiment Example 9.

FIG. 5 is a micrograph of the surface of the hydrogen permeable member obtained in Experiment Example 10.

### DESCRIPTION OF THE PREFERRED EMBODIMENTS

The hydrogen permeable member according to the present invention is characterized by it structure. That is, it is composed of a metal porous body and a hydrogen permeable membrane placed thereon, with a diffusion preventing layer interposed between them, and the metal porous body has those parts on which the diffusion preventing layer is absent and such parts are filled with metal oxide particles and/or porous metal oxide. This structure will be described in detail with reference to the accompanying drawings. (The structure is not restricted to the one shown in the drawings.)

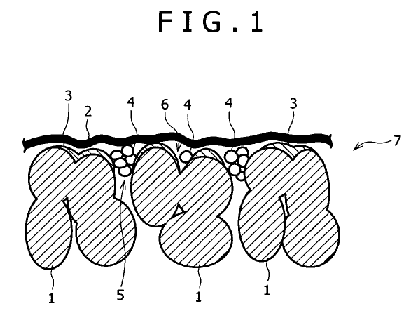

FIG. 1 is an enlarged schematic sectional view showing the hydrogen permeable membrane pertaining to the present invention. The reference numerals in FIG. 1 denote the following components.
1: Metal porous body
2: Hydrogen permeable membrane
3: Diffusion preventing layer
4: Metal oxide particles
5 and 6: Those parts of the metal porous body on which the diffusion preventing layer is absent
7: Hydrogen permeable member
   Incidentally, the part 5 corresponds to a pore that opens in the surface of the metal porous body, and the part 6 corresponds to a recess that appears in the surface of the metal porous body.

It is to be noted in FIG. 1 that the metal porous body is not completely covered by the diffusion preventing layer 3. In other words, the diffusion preventing layer is partially absent on some parts of the metal porous body. Such parts include pores 5 that open in the surface of the metal porous body (in the neighborhood of the interface adjacent to the hydrogen permeable membrane) and recesses 6 that appear in the surface of the metal porous body. According to the present invention, the pores 5 and recesses 6 mentioned above are filled with metal oxide particles and/or porous metal oxide. This structure prevents the hydrogen permeable membrane 2 from coming into direct contact with the metal porous body 1. Thus it prevents the metal constituting the metal porous body 1 from diffusing into the hydrogen permeable membrane 2, thereby producing the effect of protecting the hydrogen permeable membrane from deterioration.

The metal porous body should be formed from an adequate metal material so that it exhibits good heat and acid resistance, good durability, and ability to be joined easily. In addition, the metal porous body should be formed from an adequate metal material so that it has the same coefficient of thermal expansion as the hydrogen permeable membrane. This means that both the metal porous body and the hydrogen permeable membrane equally expand or contract as they are heated or cooled. Thus the hydrogen permeable membrane is exempt from stress that leads to defect.

Unfortunately, the metal material mentioned above often contains Fe, Ni, Cr, etc. as alloying elements or inevitable impurities. Such elements tend to diffuse into the hydrogen permeable membrane across the boundary between the metal porous body and the hydrogen permeable membrane. And diffused elements alloy with the hydrogen permeable membrane to cause its deterioration. Contact between the metal porous body and the hydrogen permeable membrane tends to occur at those parts of the metal porous body where there are pores that open in the surface of the metal porous body and recesses that appear in the surface of the metal porous body. Such pores and recesses prevent the diffusion preventing layer from being formed thereon.

According to the present invention, the foregoing problem is addressed by filling pores and recesses with metal oxide particles or porous metal oxide which resist reduction in the hydrogen atmosphere and remain stable at high temperatures (about 600° C.) required for hydrogen separation. Thus such metal oxide particles or porous metal oxide do not permit metal elements contained therein to diffuse into the hydrogen permeable membrane which is in direct contact with them.

The above-mentioned metal oxide may be formed from such metals as Al, Si, Zr, Ti, Mg, Y, Cd, Ga, Ge, Sr, Cr, Ta, Nb, Mn, La, and Li. Therefore, they may be selected from those of Al₂O₃ (alumina), SiO₂ (silica), ZrO₂ (zirconia), TiO₂ (titania), MgO, Y₂O₃, CdO, Ga₂O₃, GeO, SrO, Cr₂O₃, TaO₂, Nb₂O₅, MnO, La₂O₃, Li₂O. These species of metal oxide may be used alone or in combination with one another. Examples of such combination include Si and Al, Mg and Ta, Nb and Ta, Mg and Si, Ga and Si, Ge and Al, Ga and Ge, Mg and Al, La and Al, Sr and Ti, and Y and V. Preferred metal oxide are those of Al₂O₃ and SiO₂, which may be used alone or in combination, or those of Al—Si complex oxide.

The above-mentioned metal oxide particles should preferably be porous ones, which have a high hydrogen permeability. Examples of porous metal oxide particles include zeolite and mesoporous metal compounds. The porous metal oxide particles are not e specifically restricted in opening ratio so long as it has an adequate one for hydrogen permeation. Similarly the porous metal oxide is not specifically restricted in opening ratio so long as it has an adequate one for hydrogen permeation.

There is no universal rule for how densely the pores and recesses should be filled with metal oxide particles and/or porous metal oxide because of difficulties in measurement. It is only necessary to fill the pores and recesses with metal oxide particles and/or porous metal oxide densely enough to prevent direct contact between the hydrogen permeable membrane and the porous metal oxide body. When loosely filled, the metal oxide particles and/or porous metal oxide do not fully produce the effect of preventing metal diffusion. Dense filling is necessary for the openings of pores and recesses in the surface layer of the metal porous body; however, the metal oxide particles and/or porous metal oxide should not be present on the outer surface of the diffusion preventing layer. Otherwise, the metal oxide particles and/or porous metal oxide existing between the diffusion preventing layer and the hydrogen permeable membrane prevent their close contact with each other and cause layer separation.

The above-mentioned metal porous body may be formed from any metal material without specific restrictions. Examples of such metal material include iron and iron alloys, and nonferrous metal, such as titanium, nickel, aluminum, and chromium, and their alloys. Of these examples, iron and iron alloys (particularly stainless steel) are preferable because of their high strength and low price.

The above-mentioned metal porous body is not limited to the one which results from the sintering of metal powder, but it also includes foamed metal or the one which results from the sintering of metal unwoven fabric or the drilling of minute holes in bulk metal. Of these examples, a porous sintered body obtained by sintering metal powder is most desirable.

The above-mentioned metal porous body is not specifically restricted in their average pore diameter. An adequate pore diameter should be established in consideration of strength (required for the support) and pressure loss (encountered at the time of hydrogen separation). A metal porous body with a large average pore diameter encounters a low pressure loss at the time of hydrogen separation, but it presents difficulties in forming a compact, thin hydrogen permeable membrane thereon. By contrast, a metal porous body with a small average pore diameter encounters a large pressure loss at the time of hydrogen separation, although it permits a compact, thin hydrogen permeable membrane to be easily formed thereon.

The above-mentioned metal porous body may be of single layer structure or double (or multiple) layer structure. For example, the metal porous body may be formed by lamination from two or more layers of metal porous body which differ in density.

The above-mentioned metal porous body is not specifically restricted in shape. It may take on any known shape, such as plate, disc, and cylinder.

The above-mentioned diffusion preventing layer is formed on the surface of the metal porous body. Unfortunately, the diffusion preventing layer does not entirely cover the surface of the metal porous body. In other words, it may be partially absent on pores that open in the surface of the metal porous body and on recesses that appear in the surface of the metal porous body.

The diffusion preventing layer may be an oxide layer originating from the metal porous body or a ceramics layer, with the latter being preferable. Incidentally, the former (or the oxide layer) may be formed by oxidizing the surface of the metal porous body. Therefore, oxidation of the metal porous body forms the diffusion preventing layer almost uniformly on the surface of the metal porous body. The resulting oxide film prevents direct contact between the metal porous body and the hydrogen permeable membrane without requiring pores and recessed being filled with metal oxide particles and/or porous metal oxide.

The above-mentioned diffusion preventing layer may be formed from ceramics such as oxide, nitride, carbide, and boride. Nitrides are preferable because of its good processability, good barrier properties, good thermal stability, and good adhesion to the hydrogen permeable membrane (of Pd or Pd alloy). Examples of nitrides include TiN, CrN, TiAlN, CrAlN, ZrN, HfN, VN, NbN, and TaN. Among preferred examples are TiN, CrN, TiAlN, and CrAlN, and TiN is most desirable.

The diffusion preventing layer is not specifically restricted in thickness so long as it is thick enough to prevent diffusion of metal from the metal porous body into the hydrogen permeable membrane. An adequate thickness is larger than about 0.1 μm, preferably larger than bout 0.2 μm, more preferably larger than about 0.3 μm. With an excessively large thickness, the diffusion preventing layer has a smaller pore diameter, which leads to poor hydrogen permeability. Therefore, the thickness of the diffusion preventing layer should be smaller than about 2 μm, preferably smaller than about 1.5 μm, more preferably smaller than about 1 μm.

The thickness of the diffusion preventing layer may be measured by observing the hydrogen permeable member under a scanning electron microscope (SEM) with a magnification of about 200 to 10000. Measurement should be made at the part in contact with the metal porous body, but measurement should not be made at the part adjacent to the openings of pores and recesses.

The metal porous body provided with the diffusion preventing layer should have an apparent average pore diameter of 0.1 to 20 μm, preferably 1 to 15 μm.

The hydrogen permeable membrane should be compact and thin so that it ensures high hydrogen permeability. It is usually a hydrogen permeable metal film made of any of Pd (palladium), V, Ti, Zr, Nb, Ta, and alloy thereof. Among preferred metals are Pd, Pd—Ag alloy, and Pd—Po (polonium) alloy. A particularly preferable one is Pd—Ag alloy, with Ag accounting for 10-30 at %, preferably 15-25 at %, more preferably 23 at %.

The above-mentioned hydrogen permeable member is not specifically restricted in thickness so long as it permits selective separation of hydrogen gas from crude gas. It should be no thinner than 1 μm, preferably no thinner than 2 μm, and more preferably no thinner than 3 μm, and it should be no thicker than 10 μm, preferably no thicker than 9 μm, and more preferably no thicker than 8 μm.

The thickness of the hydrogen permeable membrane may be measured by observing the hydrogen permeable member under a scanning electron microscope (SEM) with a magnification of about 1000 to 5000. Measurement should be made at the part on the surface of the metal porous body, but measurement should not be made at the part adjacent to the openings of pores and recesses.

The following is concerned with the method for production of the hydrogen permeable member according to the present invention. The hydrogen permeable member according to the present invention is comprised of a metal porous body and a hydrogen permeable membrane, with a diffusion preventing layer interposed between them, which are sequentially placed on top of the other. The hydrogen permeable member constructed in such a way is produced by covering the surface of the metal porous body 1 with the diffusion preventing layer 3, filling with the metal oxide particles the openings of pores 5 or recesses 6 in the surface of the metal porous body on which the diffusion preventing layer is absent, and finally forming the hydrogen permeable membrane 2. (See FIG. 1.)

The metal porous body may be selected from a metal foam, a porous sintered body formed by sintering metal powder or metal nonwoven fabric, and a porous body formed by drilling minute holes in bulk metal. They may be produced by any known method. For example, the porous sintered body of metal powder may be produced by sintering compacts formed by cold isostatic pressing (CIP) or hot isostatic pressing (HIP) or combination thereof. The metal powder for sintering should be one which has an average particle diameter of about 1 to 100 μm, preferably about 4 to 45 μm.

The next step is to cover the surface of the metal porous body with the diffusion preventing layer by any known method. A desirable method is physical vapor deposition, such as sputtering and arc ion plating, for the diffusion preventing layer of ceramics.

The next step is to put metal oxide particles and/or porous metal oxide in pores and recesses that open in the surface of the metal porous body. This step may be accomplished in any way without specific restrictions as exemplified below.
(1) Rubbing previously prepared metal oxide particles into pores and recesses that open in the surface of the metal porous body.
(2) Coating the metal porous body with a slurry of metal oxide, followed by drying.
(3) Coating the metal porous body with a sol (which subsequently forms metal oxide), followed by gelling.
(4) Filtering a slurry through the metal porous body (as a filter medium), thereby filling pores in the metal porous body with slurry solids, followed by drying.

Coating in (2) and (3) may be accomplished by spin coating, dip coating, or spray coating. Incidentally, the surface of the metal porous body should be cleared of excess metal oxide particles and/or porous metal oxide so that the openings and recesses will not be filled with more metal oxide particles and/or porous metal oxide than necessary.

The metal oxide particles are not specifically restricted in particle diameter so long as they are fine enough to be put in pores and recesses that open in the surface of the metal porous body. Those which have an average particle diameter of about 0.01 to 45 μm are desirable from the standpoint of superficial velocity and ease with which the hydrogen permeable membrane is formed. The preferred average particle diameter ranges from 0.03 μm to 20 μm (desirably 10 μm).

It is possible to use two or more kinds of metal oxide particles differing in average particle diameter. Their selection depends on the size of the openings of pores and recesses. For example, openings larger than about 50 μm in diameter should be filled first with coarse metal oxide particles with an average particle diameter of about 45 μm, and then with medium metal oxide particles with an average particle diameter of about 20 μm, and finally with fine metal oxide particles with an average particle diameter of about 4 μm. It is also possible to use metal oxide particles having distributed particle diameters.

After the metal oxide particles and/or porous metal oxide have been put in pores and recesses that open in the surface of the metal porous body, the hydrogen permeable membrane is formed. This step may be accomplished by any method, such as physical vapor deposition, chemical vapor deposition, plating, and frame spraying, with the first one being preferable because of its easy operation and its ability to give a high-performance membrane. Preferred methods of physical vapor deposition are sputtering and (arc) ion plating. Physical vapor deposition yields a hydrogen permeable membrane with good adhesion to the diffusion preventing layer or metal oxide particles or porous metal oxide. This good adhesion prevents the hydrogen permeable membrane from peeling off from the metal porous body even though it swells due to absorption of hydrogen when the hydrogen permeable member is in operation.

If physical vapor deposition is employed to form the hydrogen permeable membrane, it is desirable to fill pores and recesses with metal oxide particles having a maximum particle diameter no larger than 1 μm. This is explained below. Physical vapor deposition causes crystals of metal constituting the hydrogen permeable membrane to gradually grow on the surface of the substrate (or the diffusion preventing layer or the metal oxide particles). The thus grown crystals of metal eventually form the hydrogen permeable membrane. In the course of this step, metal grows into columnar crystals perpendicular to the surface of the substrate. A smooth surface on the substrate permits such columnar crystals to closely grow on it to form a hydrogen permeable membrane composed of crystals without interstices. However, a rough surface on the substrate causes metal to irregularly grow from projecting or depressed parts, thereby yielding loosely grown columnar crystals. Interstices between crystals result in a defective hydrogen permeable membrane, which leads to a hydrogen permeable member with poor hydrogen permeability. The foregoing will be described with reference to the drawings.

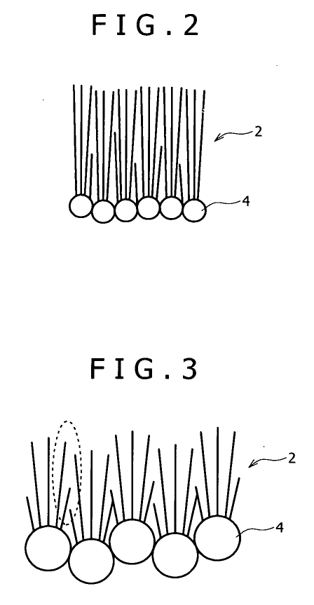

FIGS. 2 and 3 are schematic diagrams showing how metal crystals grow, in which reference numerals 2 and 4 denote the hydrogen permeable membrane and the metal oxide particles, respectively.

It is assumed that the hydrogen permeable membrane is formed by physical vapor deposition on the surface of the substrate (which is metal oxide particles in FIGS. 2 and 3) In this case the above-mentioned columnar crystals grow in different manner. If the metal oxide particles 4 have a small particle diameter and a smooth surface, as shown in FIG. 2, the columnar crystals regularly grow upward to yield the hydrogen permeable membrane without interstices among crystals. By contrast, if the metal oxide particles 4 have a large particle diameter and a rough surface, as shown in FIG. 3, the columnar crystals grow in various directions, leaving interstices (surrounded by dotted lines in FIG. 3) between crystals. These interstices become defects in the hydrogen permeable membrane. Consequently, it is desirable to use fine metal oxide particles having a maximum particle diameter no larger than 1 μm, preferably no larger than 0.5 μm, if physical vapor deposition is to be employed for the hydrogen permeable membrane.

The average and maximum particle diameter of the metal oxide particles may be determined from particle size distribution measured by laser diffraction method. A typical instrument for measurement is “SALD-2000J” from Shimadzu Corp.

According to the present invention, the average particle diameter is defined as D₁ μm if particles having diameters up to D₁ μm account for 50% (in terms of number) in the particle size distribution, and the maximum particle diameter is defined as D₂ μm if particles having diameter up to D₂ μm account for 99% (in terms of number) in the particle size distribution.

An adequate dispersion medium for measurement should be selected according to the material of the metal oxide particles. For example, a dispersion medium suitable for silica or alumina particles is deionized water or ethanol (the former may contain about 0.2 wt % of sodium metaphosphate as a dispersing agent). An ultrasonic cleaner or the like may be employed to facilitate dispersion of the metal oxide particles into a dispersion medium.

### EXAMPLES

The invention will be described with reference to the following examples which are not intended to restrict the scope thereof, with understanding that it is subject to changes and modifications within the scope thereof.

### Example 1

A stainless steel discoid support, 20 mm in diameter and 1 mm thick, was made by CIP method from stainless steel powder having an average particle diameter of 10 μm. After dewaxing at 600° C., it was sintered at 950° C. in an inert gas atmosphere to give a metal porous body (in the form of sintered body).

The metal porous body had its surface covered with a diffusion preventing layer of TiN by arc ion plating that employed a Ti target and an arc current of 150 A in the chamber containing nitrogen gas at a partial pressure of 2.7 Pa. The resulting product was designated as the porous body A.

By observation under an SEM (×5000), it was confirmed that there are openings about 2-4 μm in diameter in the surface of the porous body A. (The term “openings” denotes openings of both pores and recesses hereinafter.) The next step was carried out to fill pores and recesses that open in the surface of the porous body A with any one kind of metal oxide porous particles or porous metal oxide prepared in the following Experiment Examples 1 to 5. Finally the porous body A was covered with a film of Pd—Ag alloy. Thus there was obtained the desired hydrogen permeable member.

### Experiment Example 1

The metal oxide porous particles were prepared in the following manner. A separable flask was charged with 37 pbw of cetyltrimethylammonium bromide [CTAB: C₁₆H₃₃(CH₃)₃NBr] and 189 pbw of ammonia water, and stirring at room temperature for 1 hour followed to dissolve CTAB in ammonia water. After addition of 41 pbw of tetraethylsilicate [TEOS: Si(OC₂H₅)₄], stirring was continued at room temperature for 1.5 hours under reflux, with a condenser tube attached to the separable flask. The resulting white turbid liquid was heated to 70° C. and stirred at this temperature under reflux. With the condenser tube removed, stirring was continued at 70° C. for 2 hours for solvent evaporation. The resulting product was filtered out and washed with deionized water, followed by drying at 100° C. for 18 hours. The dried product was heated to 550° C. (at a heating rate of 3° C./min in a nitrogen atmosphere and then baked by keeping at 550° C. for 2 hours. Thus there was obtained mesoporous silica (as the metal oxide porous particles). It was found to have an average pore diameter of 3.7 nm (37 Å) through measurements by Horvath-Kawazoe method that employs nitrogen adsorption isotherm.

The mesoporous silica was crushed to a fine powder having an average particle diameter of 1 μm by using a mortar and pestle. The resulting mesoporous silica powder was rubbed into pores and recesses that open in the surface layer of the porous body A, and its excess portion was removed. Observation of the surface of the porous body A under an SEM (×5000) revealed that the mesoporous silica powder existed in those parts where the diffusion preventing layer is absent but it did not exist on the diffusion preventing layer.

### Experiment Example 2

The metal oxide porous particles were prepared from FAU zeolite powder (“Synthetic Zeolite F-9 Powder” from Toso) by crushing with a mortar and pestle to a fine powder having an average particle diameter of 1 μm. The resulting FAU zeolite powder was rubbed onto the surface of the porous body A, and its excess portion was removed. Observation of the surface of the porous body A under an SEM (×5000) revealed that the FAU powder existed in those parts where the diffusion preventing layer is absent but it did not exist on the diffusion preventing layer.

### Experiment Example 3

The porous body A was immersed in a sol composed of water glass, sodium aluminate, sodium hydroxide, and deionized water, with the molar ratio of their constituents being Al₂O₃:SiO₂:Na₂O₃:H₂O=1:19.2:17:975. (This sol is a raw material for synthetic zeolite as the porous metal oxide.) The sol underwent hydrothermal synthesis in an autoclave at 90° C. for 24 hours.

Subsequent steps were washing with deionized water, ultrasonic cleaning, drying, and surface polishing to remove excess porous metal oxide from the surface of the porous body A. Observation of the surface of the porous body A under an SEM (×5000) revealed that the porous metal oxide existed in those parts where the diffusion preventing layer is absent but they did not exist on the diffusion preventing layer. In addition, examination by X-ray diffraction revealed that the porous metal oxide existing in those parts where the diffusion preventing layer is absent was FAU zeolite.

### Experiment Example 4

The filling of pores and recesses on the surface of the porous body A with porous metal oxide was carried out in the following manner. First, a separable flask was charged with 12 pbw of ethanol and 5 pbw of catalyst (aqueous solution of nitric acid, pH=3.0). After thorough mixing, the separable flask was further charged with 11 pbw of tetraethylorthosilicate [TEOS: Si(OC₂H₅)₄], followed by reaction with stirring for 3 hours on a hot water bath at 60° C. After addition of 3 pbw of cetyltrimethylammonium bromide [CTAB: C₁₆H₃₃(CH₃)₃NBr], stirring was continued to dissolve CTAB. In the resulting solution was immersed the porous body A for 10 minutes. With its surface cleaned with ethanol, the porous body A was dried in an oven at 100° C. and then baked under a nitrogen stream in a furnace at 550° C. for 2 hours after heating at a rate of 3° C./min.

Observation of the surface of the porous body A under an SEM (×5000) revealed that the porous metal oxide existed in those parts where the diffusion preventing layer is absent but they did not exist on the diffusion preventing layer. In addition, examination by X-ray diffraction revealed that the porous metal oxide existing in pores and recesses was mesoporous silica.

### Experiment Example 5

The porous body A was immersed in a solution at 40° C. for 24 hours, which was prepared from 15 pbw of methyltrimethoxysilane [MTMS: SiCH₃(OCH₃)₃] reacted for 5 minutes by stirring with a homogenous solution of 1M nitric acid (4 pbw) and methanol (4 pbw) in a separable flask. After drying, the surface of the porous body was polished to remove excess porous metal oxide.

Observation of the surface of the porous body A under an SEM (×5000) revealed that the porous metal oxide existed in those parts where the diffusion preventing layer is absent but they did not exist on the diffusion preventing layer. Incidentally, the porous metal oxide existing in pores and recesses were found to have pores with a diameter of about 0.1 μm.

Samples of the porous bodies obtained in Experiment Examples 1 to 5 above, which carry the metal oxide porous particles and the porous metal oxide, were covered with a Pd—Ag alloy film (as the hydrogen permeable membrane) by arc ion plating or sputtering.

Arc ion plating was carried out by using a Pd—Ag alloy (containing 23 at % Ag) as the target, with the atmosphere in the chamber replaced by argon gas at a partial pressure of 2.7 Pa (20 mTorr). An arc current of 80 A was applied to the target for arc discharging to form a Pd—Ag alloy film (containing 23 at % Ag), 6 μm thick, on the surface of the porous body.

Sputtering was performed by using a Pd—Ag alloy (containing 23 at % Ag) as the target, 6 inches in diameter, with the atmosphere in the chamber replaced by argon gas at a partial pressure of 0.3 Pa. Discharge with a DC power of 500 W was made across the target (negative) and the work (positive) for sputtering to form a Pd—Ag film (containing 23 at % Ag), 6 μm thick, on the surface of the porous body.

For the purpose of comparison, a Pd—Ag alloy film as the hydrogen permeable membrane was formed on the surface of the above-mentioned metal porous body by arc ion plating or sputtering according to the processes demonstrated in Experiment Examples 6 to 8 that follow.

### Experiment Example 6

A sample of the hydrogen permeable member was prepared by covering the surface of the porous body A (mentioned above) directly with a Pd—Ag alloy film as the hydrogen permeable membrane.

### Experiment Example 7

The same procedure as in Experiment Example 2 was repeated to give the hydrogen permeable member except for the step of clearing the surface of the porous body A of excess crushed FAU zeolite powder.

The surface of the porous body not yet covered with the hydrogen permeable membrane was observed under an SEM (×5000). Observation revealed that the zeolite powder existed not only in those parts where the diffusion preventing layer is absent but also on the diffusion preventing layer.

### Experiment Example 8

A sample of hydrogen permeable member was prepared by rubbing crushed mesoporous silica (prepared in the same way as in Experiment Example 1) into the metal porous sintered body without the diffusion preventing layer. Incidentally, observation of the surface of the metal porous sintered body under an SEM (×5000) revealed that pores therein have openings of about 2-4 μm in diameter.

The samples of the hydrogen permeable members obtained in Experiment Examples 1 to 8 above were examined as follows for (1) adhesion between the hydrogen permeable membrane and the porous body, (2) hydrogen permeability, (3) the presence or absence of pinholes, and (4) deterioration of the hydrogen permeable membrane. The results of examination are shown in Table 1 below. Incidentally, Samples Nos. 13 and 14 were so poor in adhesion that they were not examined for the items (2) to (4).

[Adhesion Between Hydrogen Permeable Membrane and Porous Body]

This property was examined by visual inspection, and the result was rated according to the following criteria.

<Criteria>

⊚: No peeling at all. (pass)
∘: Slight peeling harmless to operation. (pass)
×: Peeling detrimental to operation (rejected)
   [Hydrogen Permeability]

The sample was tested for hydrogen permeability by supplying pure hydrogen gas to the hydrogen permeable membrane such that a pressure difference of 98 kPa (1 kgf/cm²) is produced between the inlet and the outlet. This test was continued at 600° C. for 3 hours, and the change with time was recorded. The result was rated according to the following criteria.

<Criteria>

∘: Good hydrogen permeability with a decrease less than 10% within 3 hours after the start of test. (pass)
×: Poor hydrogen permeability with a decrease more than 10% within 3 hours after the start of test. (rejected)
   [Presence or Absence of Pinholes]

The sample that had undergone hydrogen permeability test was examined for pinholes in the hydrogen permeable membrane by measuring the amount of air that passes through the sample at room temperature. The result was rated according to the following criteria.

<Criteria>

∘: Absent. (pass)
×: Present. (rejected)
   [Deterioration of Hydrogen Permeable Membrane]

The sample that had undergone the hydrogen permeability test was examined as follows for diffusion of metal from the metal porous sintered body into the hydrogen permeable membrane. Diffusion of metal is a measure of deterioration.

After the hydrogen permeability test, the sample was cut and its exposed cross-section was embedded in resin and then mirror finished. Observations under an SEM (×5000 and ×15000) were carried out to see metal diffusion into the hydrogen permeable membrane.

The specimen was also inspected by detecting Auger electrons to see if metal had diffused from the metal porous sintered body into the hydrogen permeable membrane.

In the case where no metal diffusion was found by the above-mentioned inspection, the specimen that had undergone the hydrogen permeability test was sliced and made into a thin film by using a focused ion beam (FIB). The thin film was observed under a TEM (×10,000, ×60,000, ×1,500,000) to see metal diffusion from the metal porous sintered body.

The thin specimen prepared as mentioned above was also analyzed by electron energy loss spectroscopy (EELS). The presence or absence of trace components was examined in the hydrogen permeable membrane at a place about 5-10 nm away from the boundary between the metal porous sintered body and the hydrogen permeable membrane. The results were rated according to the following criteria.

<Criteria>

∘: No metal diffusion is detected by Auger observation and EELS analysis and the hydrogen permeable membrane remains intact. (pass)

×: Metal diffusion is detected by Auger observation and EELS analysis and the hydrogen permeable membrane is deteriorated. (rejected)

TABLE 1

| Sample | Experiment | Film forming | Film thickness | | Hydrogen | | Deterioration |
|---|---|---|---|---|---|---|---|
| No. | Example | method | (μm) | Adhesion | permeability | Pinholes | of film |
| 1 | 1 | Sputtering | 6 | ⊚ | ◯ | ◯ | ◯ |
| 2 | 1 | Arc ion plating | 6 | ⊚ | ◯ | ◯ | ◯ |
| 3 | 2 | Sputtering | 6 | ⊚ | ◯ | ◯ | ◯ |
| 4 | 2 | Arc ion plating | 6 | ⊚ | ◯ | ◯ | ◯ |
| 5 | 3 | Sputtering | 6 | ⊚ | ◯ | ◯ | ◯ |
| 6 | 3 | Arc ion plating | 6 | ⊚ | ◯ | ◯ | ◯ |
| 7 | 4 | Sputtering | 6 | ⊚ | ◯ | ◯ | ◯ |
| 8 | 4 | Arc ion plating | 6 | ⊚ | ◯ | ◯ | ◯ |
| 9 | 5 | Sputtering | 6 | ⊚ | ◯ | ◯ | ◯ |
| 10 | 5 | Arc ion plating | 6 | ⊚ | ◯ | ◯ | ◯ |
| 11 | 6 | Sputtering | 6 | ⊚ | X | X | X |
| 12 | 6 | Arc ion plating | 6 | ⊚ | X | X | X |
| 13 | 7 | Sputtering | 6 | X | — | — | — |
| 14 | 7 | Arc ion plating | 6 | X | — | — | — |
| 15 | 8 | Sputtering | 6 | ◯ | X | ◯ | X |
| 16 | 8 | Arc ion plating | 6 | ◯ | X | ◯ | X |

It is noted from Table 1 that Sample Nos. 1 to 10 meet the requirements of the present invention and hence they are exempt from diffusion of metal from the metal porous sintered body into the hydrogen permeable membrane and they keep the hydrogen permeable membrane intact. By contrast, sample Nos. 11 to 16 do not meet the requirements of the present invention and hence they permit metal to diffuse from the metal porous sintered body into the hydrogen permeable membrane.

### Example 2

Samples of the hydrogen permeable member were prepared by filling pores and recesses that open in the surface of the porous body A (obtained in Example 1) with metal oxide porous particles prepared in Experiment Examples 9 and 10 that follow and then forming thereon a Pd—Ag alloy film as the hydrogen permeable membrane.

### Experiment Example 9

The surface of the porous body A was rubbed with silica sol (“Snowtex XL” from Nissan Chemical), having a maximum particle diameter of 0.06 μm, as the metal oxide porous particles. With excess particles removed, the surface of the porous body was observed under an SEM (5000). It was found that silica sol exists in those parts where the diffusion preventing layer is absent but does not exist on the diffusion preventing layer.

### Experiment Example 10

The surface of the porous body A was rubbed with FAU zeolite powder (“Synthetic Zeolite F-9 Powder” from Toso) as the metal oxide porous particles. The FAU zeolite powder was used in the form of fine powder having an average particle diameter of 2.1 μm after crushing with a mortar and pestle. With excess particles removed, the surface of the porous body was observed under an SEM (5000). It was found that FAU zeolite powder exists in those parts where the diffusion preventing layer is absent but does not exist on the diffusion preventing layer.

Each of the porous bodies which had been rubbed with metal oxide porous particles in Experiment Examples 9 and 10 was coated with a Pd—Ag film, 6 μm thick, (as the hydrogen permeable membrane) by sputtering under the same condition as in Example 1.

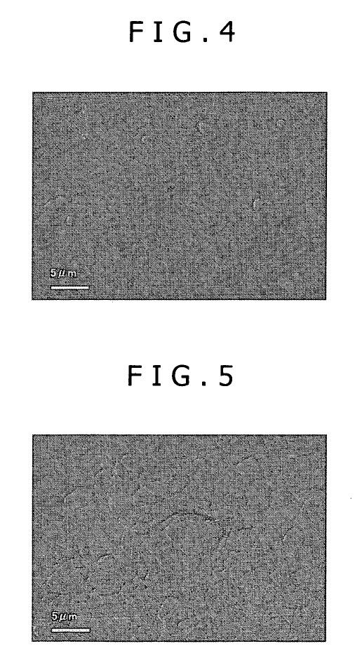

The surface of the hydrogen permeable member was photographed through an SEM (×3000). The microphotographs in Experiment Examples 9 an 10 are shown in FIGS. 4 and 5, respectively.

It is apparent from FIG. 4 that the hydrogen permeable membrane has a smooth surface with very few irregularities. By contrast, it is apparent from FIG. 5 that course metal oxide porous particles (having the maximum particle diameter larger than 1 μm) give rise to large surface irregularities. Thus, such course particles are more liable to cause defects than fine particles (with the maximum particle diameter smaller than 1 μm) when the membrane is formed by physical vapor deposition.

What is claimed is:

1. A hydrogen permeable member composed of a metal porous body and a hydrogen permeable membrane placed thereon, with a diffusion preventing layer interposed between them, wherein the metal porous body has those parts on which the diffusion preventing layer is absent and such parts are filled with metal oxide particles and/or porous metal oxide.

2. The hydrogen permeable member as defined in claim 1, wherein the metal porous body is a sintered body of stainless steel.

3. The hydrogen permeable member as defined in claim 1, wherein the hydrogen permeable membrane is a hydrogen permeable metal film.

4. The hydrogen permeable member as defined in claim 3 wherein the hydrogen permeable metal film is a film of Pd or alloy thereof.

5. The hydrogen permeable member as defined in claim 1, wherein the diffusion preventing layer is a ceramics layer.

6. The hydrogen permeable member as defined in claim 1, wherein the metal oxide particles have the maximum particle diameter no larger than 1 μm.

7. A hydrogen permeable member composed of a metal porous body and a hydrogen permeable membrane placed thereon, with a diffusion preventing layer interposed between them, wherein the metal porous body has pores that open in the surface thereof and/or recesses that appear in the surface thereof, and the openings of such pores and/or recesses are filled with metal oxide particles and/or porous metal oxide.

8. The hydrogen permeable member as defined in claim 7, wherein the metal porous body is a sintered body of stainless steel.

9. The hydrogen permeable member as defined in claim 7, wherein the hydrogen permeable membrane is a hydrogen permeable metal film.

10. The hydrogen permeable member as defined in claim 9, wherein the hydrogen permeable metal film is a film of Pd or alloy thereof.

11. The hydrogen permeable-member as defined in claim 7, wherein the diffusion preventing layer is a ceramics layer.

12. The hydrogen permeable member as defined in claim 7, wherein the metal oxide particles have the maximum particle diameter no larger than 1 μm.

13. A method of producing a hydrogen permeable member, said method comprising steps of providing a metal porous body with a diffusion preventing layer on the surface thereof, filling with metal oxide particles and/or porous metal oxide those parts of the metal porous body on which the diffusion preventing layer is absent, and finally forming a hydrogen permeable membrane on the diffusion preventing layer.

14. The method as defined in claim 13, wherein the diffusion preventing layer is formed by physical vapor deposition.

15. The method as defined in claim 13, wherein the hydrogen permeable membrane is formed by physical vapor deposition.

16. The method as defined in claim 13, wherein the metal oxide particles are those which have the maximum particle diameter no larger than 1 μm and the hydrogen permeable membrane is formed by physical vapor deposition.

17. A method of producing a hydrogen permeable member, said method comprising steps of providing a metal porous body with a diffusion preventing layer on the surface thereof, filling with metal oxide particles and/or porous metal oxide pores that open in the surface thereof and/or recesses that appear in the surface thereof, and finally forming a hydrogen permeable membrane on the diffusion preventing layer.

18. The method as defined in claim 17, wherein the diffusion preventing layer is formed by physical vapor deposition.

19. The method as defined in claim 17, wherein the hydrogen permeable membrane is formed by physical vapor deposition.

20. The method as defined in claim 17, wherein the metal oxide particles are those which have the maximum particle diameter no larger than 1 μm and the hydrogen permeable membrane is formed by physical vapor deposition.
